(19) United States
(12) Patent Application Publication
(10) Pub. No.: US 2019/0043086 A1
(43) Pub. Date: Feb. 7, 2019

(54) SYSTEMS AND METHODS FOR LONG-TERM, MULTI-STAGE USER ENGAGEMENT

(71) Applicant: Conversable, Inc., Austin, TX (US)

(72) Inventors: Andrew Thomas BUSEY, Austin, TX (US); Anthony Dan CHEN, Austin, TX (US); Isao Uchida JONAS, Austin, TX (US); Douglas James DANIELS, JR., Austin, TX (US); Benjamin Edward LAMM, Dallas, TX (US)

(21) Appl. No.: 16/054,415

(22) Filed: Aug. 3, 2018

Related U.S. Application Data
(60) Provisional application No. 62/541,595, filed on Aug. 4, 2017.

(51) Int. Cl. G06Q 30/02; G06Q 50/00; H04L 12/58

(52) U.S. Cl. CPC G06Q 30/0258; H04L 51/04; G06Q 50/01

(57) ABSTRACT

Disclosed herein are platforms, systems, media, and methods for automatic, long-term, multi-stage user engagement that facilitate repeated user interaction and user acquisition from the provision of a single link to content, which is a significant deviation from the traditional operation of links on the web and in mobile environments.

### CROSS-REFERENCE

This application claims priority to U.S. Provisional Patent Application No. 62/541,595, filed Aug. 4, 2017, which is entirely incorporated herein by reference.

### BACKGROUND OF THE INVENTION

Social networking and media applications are now ubiquitous. Moreover, mobile messaging applications are growing ever more popular as they add social networking features.

### SUMMARY OF THE INVENTION

Brands need to actively pursue customers (users) in the social and messaging channels they're already using, typically through the use of links directing the user to content providing information about the brand's products (e.g., advertisements). However, existing content delivery technologies only provide a single transitory interaction with the user and require the user to manually provide contact information (such as an email address) in order to receive further information about the content of interest. Without the ability to automatically follow-up with the user with additional brand information or content, brands must provide the user with a second link directed to the additional content and are reliant upon the user manually interact with the second link. Disclosed herein is a social enterprise software platform for long-term, multi-stage user-engagement that automatically provides customers with content of interest via the social and messaging applications that they are already using. Importantly, the platforms described herein fundamentally alter the way in which users interact with links directed to content by identifying and logging the user in a database of users for follow-up communication and automatically re-engaging with the user at a later point in time with additional content or information, a feature absent from current one-and-done content-delivery technologies.

Disclosed herein, in some embodiments, is computer-implemented system comprising: a digital processing device comprising: at least one processor, an operating system configured to perform executable instructions, a memory, and a computer program including instructions executable by the digital processing device to create an application for long-term, multi-stage user engagement comprising: an interaction module identifying a user that interacts with a link providing access to content, wherein the identity of the user on an electronic communications platform is known, and wherein the content is associated with a product or an event; a flagging module storing the user's contact information and logging the user in a database of users for a follow-up communication using the identity of the user on the electronic communications platform; and a re-engagement module automatically re-engaging with the user by sending the user a first message comprising additional content via an interactive chat feature of the electronic communications platform, wherein the additional content is associated with the product or the event. In some embodiments, the link is public or private. In some embodiments, the content or the additional content comprises a date associated with the product or the event. In some embodiments, the content or the additional content provides information of the product or the event. In some embodiments, the information is customized based on the identity of the user on the electronic communications platform. In some embodiments, the re-engagement module automatically re-engages with the user by sending the user the first message substantially instantaneously after the user interacts with the link. In some embodiments, the re-engagement module automatically re-engages with the user by sending the user the first message after a predetermined condition condition has been met. In some embodiments, the predetermined condition is a duration of time, a date, a time point, or onset of an event. In some embodiments, the interaction module allows the user to interact with the first message. In some embodiments, the re-engagement module further automatically re-engages with the user by sending the user a second message comprising further additional content associated with the product or the event. In some embodiments, the further additional content comprises a date associated with the product or the event. In some embodiments, the first message or the second message is private. In some embodiments, the re-engagement module automatically re-engages with the user by sending the second message substantially instantaneously after the user interacts with the first message. In some embodiments, the re-engagement module automatically re-engages with the user when a predetermined condition has been met after the first message has been sent. In some embodiments, the interaction module allows the user to interact with the second message. In some embodiments, the second message is sent via an interactive chat feature of the electronic communication platform or a second electronic communication platform. In some embodiments, the further additional content provides specific features of the product or the event that is only available to the user after the user interacts with the first message, the second message, or both. In some embodiments, the user interaction with the link, first message, or second message is via an input device. In some embodiments, the input device comprises one or more of: a touchscreen, a keyboard, a pointing device, a camera, and a microphone. In some embodiments, the re-engagement module allows the user to subscribe to notifications about the product or event. In some embodiments, the first message or the second message comprises access allowing the user to automatically subscribe to notifications about the product or event. In some embodiments, the content is an advertisement. In some embodiments, the advertisement is for a movie, a new product release, a recreational event, a social event, an educational event, or a political event. In some embodiments, the electronic communications platform is Facebook, Instagram, or Twitter. In some embodiments, the system herein further comprises a response module automatically responding to the interaction with a first message about the content via an interactive chat feature of an electronic communication platform. In some embodiments, the system herein further comprises a subscription module configured to allow the user to subscribe to notifications about the content.

Disclosed herein, in some embodiments, is a computer-implemented system comprising: a digital processing device comprising: at least one processor, an operating system configured to perform executable instructions, a memory, and a computer program including instructions executable by the digital processing device to create an application for long-term, multi-stage user engagement comprising: an interaction module identifying a user that interacts with a link providing access to content, wherein the identity of the user on an electronic communications platform is known, and wherein the content is associated with a product or an event; a response module automatically responding to the interaction with a first message comprising additional content via an interactive chat feature of the electronic communication platform, the additional content associated with the product or event; a subscription module configured to allow the user to subscribe to notifications about the content; a flagging module storing the user's contact information and logging the user in a database of users for a follow-up communication using the identity of the user on the electronic communications platform; and a re-engagement module automatically re-engaging with the user by sending the user a second message comprising further additional content via an interactive chat feature of the electronic communications platform, wherein the further additional content is associated with the product or the event. In some embodiments, the subscription module is configured to allow the user to subscribe to notifications about the content is via the first message or the second message. In some embodiments, the subscription module is configured to allow the user to subscribe to notifications about the content does not require manual input of user's contact information. In some embodiments, the notifications about the content are within the electronic communication platform. In some embodiments, the link, the first message, or the second message is public or private. In some embodiments, the content, the additional content, or the further additional content comprises a date associated with the product or the event. In some embodiments, the additional content, or the further additional content provides information of the product or the event. In some embodiments, the information is customized based on the identity of the user on the electronic communications platform. In some embodiments, the first message is sent substantially instantaneously after the user interacts with the link. In some embodiments, the first message is sent after a predetermined condition has been met. In some embodiments, the predetermined condition is a duration of time, a date, a time point, or onset of an event. In some embodiments, the interaction module allows the user to interact with the first message, the second, message, or both. In some embodiments, the re-engagement module automatically re-engages with the user by sending the second message substantially instantaneously after the user interacts with the first message. In some embodiments, the re-engagement module automatically re-engages with the user when a predetermined condition has been met after the first message has been sent. In some embodiments, the second message is sent via an interactive chat feature of the electronic communication platform or a second electronic communication platform. In some embodiments, the further additional content provides specific features of the product or the event that is only available to the user after the user interacts with the first message, the second message, or both. In some embodiments, the user interaction with the link, first message, or second message is via an input device. In some embodiments, the input device comprises one or more of: a touchscreen, a keyboard, a pointing device, a camera, and a microphone. In some embodiments, the first message or the second message comprises access allowing the user to automatically subscribe to notifications about the product or event. In some embodiments, the content is an advertisement. In some embodiments, the advertisement is for a movie, a new product release, a recreational event, a social event, an educational event, or a political event. In some embodiments, the electronic communications platform is Facebook, Instagram, or Twitter.

Disclosed herein, in some embodiments, is non-transitory computer-readable storage media encoded with a computer program including instructions executable by a processor to create a long-term, multi-stage user engagement response application comprising: an interaction module identifying a user that interacts with a link providing access to content, wherein the identity of the user on an electronic communications platform is known, and wherein the content is associated with a product or an event; a response module automatically responding to the interaction with a first message comprising additional content via an interactive chat feature of the electronic communication platform, the additional content associated with the product or event; a subscription module configured to allow the user to subscribe to notifications about the content; a flagging module storing the user's contact information and logging the user in a database of users for a follow-up communication using the identity of the user on the electronic communications platform; and a re-engagement module automatically re-engaging with the user by sending the user a second message comprising further additional content via an interactive chat feature of the electronic communications platform, wherein the further additional content is associated with the product or the event. In some embodiments, the subscription module is configured to allow the user to subscribe to notifications about the content is via the first message or the second message. In some embodiments, the subscription module is configured to allow the user to subscribe to notifications about the content does not require manual input of user's contact information. In some embodiments, the notifications about the content are within the electronic communication platform. In some embodiments, the link, the first message, or the second message is public or private. In some embodiments, the content, the additional content, or the further additional content comprises a date associated with the product or the event. In some embodiments, the additional content, or the further additional content provides information of the product or the event. In some embodiments, the information is customized based on the identity of the user on the electronic communications platform. In some embodiments, the first message is sent substantially instantaneously after the user interacts with the link. In some embodiments, the first message is sent after a predetermined condition has been met. In some embodiments, the predetermined condition is a duration of time, a date, a time point, or onset of an event. In some embodiments, the interaction module allows the user to interact with the first message, the second, message, or both. In some embodiments, the re-engagement module automatically re-engages with the user by sending the second message substantially instantaneously after the user interacts with the first message. In some embodiments, the re-engagement module automatically re-engages with the user when a predetermined condition has been met after the first message has been sent. In some embodiments, the second message is sent via an interactive chat feature of the electronic communication platform or a second electronic communication platform. In some embodiments, the further additional content provides specific features of the product or the event that is only available to the user after the user interacts with the first message, the second message, or both. In some embodiments, the user interaction with the link, first message, or second message is via an input device. In some embodiments, the input device comprises one or more of: a touchscreen, a keyboard, a pointing device, a camera, and a microphone. In some embodiments, the first message or the second message comprises access allowing the user to automatically subscribe to notifications about the product or event. In some embodiments, the content is an advertisement. In some embodiments, the advertisement is for a movie, a new product release, a recreational event, a social event, an educational event, or a political event. In some embodiments, the electronic communications platform is Facebook, Instagram, or Twitter.

Disclosed herein, in some embodiments, is a computer-implemented method of long-term, multi-stage user engagement comprising: identifying a user that interacts with a link providing access to content, wherein the identity of the user on an electronic communications platform is known, and wherein the content is associated with a product or an event; automatically responding to the interaction with a first message comprising additional content via an interactive chat feature of an electronic communication platform, the additional content associated with the product or event; receiving a subscription from the user to receive future notifications about the content; storing the user's contact information and logging the user in a database of users for a follow-up communication using the identity of the user on the electronic communications platform; and automatically re-engaging with the user by sending the user a second message comprising further additional content via an interactive chat feature of an electronic communication platform, wherein the further additional content is associated with the product or the event. In some embodiments, the subscription module is configured to allow the user to subscribe to notifications about the content is via the first message or the second message. In some embodiments, the subscription module is configured to allow the user to subscribe to notifications about the content does not require manual input of user's contact information. In some embodiments, the notifications about the content are within the electronic communication platform. In some embodiments, the link, the first message, or the second message is public or private. In some embodiments, the content, the additional content, or the further additional content comprises a date associated with the product or the event. In some embodiments, the additional content, or the further additional content provides information of the product or the event. In some embodiments, the information is customized based on the identity of the user on the electronic communications platform. In some embodiments, the first message is sent substantially instantaneously after the user interacts with the link. In some embodiments, the first message is sent after a predetermined condition has been met. In some embodiments, the predetermined condition is a duration of time, a date, a time point, or onset of an event. In some embodiments, the interaction module allows the user to interact with the first message, the second, message, or both. In some embodiments, the re-engagement module automatically re-engages with the user by sending the second message substantially instantaneously after the user interacts with the first message. In some embodiments, the re-engagement module automatically re-engages with the user when a predetermined condition has been met after the first message has been sent. In some embodiments, the second message is sent via an interactive chat feature of the electronic communication platform or a second electronic communication platform. In some embodiments, the further additional content provides specific features of the product or the event that is only available to the user after the user interacts with the first message, the second message, or both. In some embodiments, the user interaction with the link, first message, or second message is via an input device. In some embodiments, the input device comprises one or more of: a touchscreen, a keyboard, a pointing device, a camera, and a microphone. In some embodiments, the first message or the second message comprises access allowing the user to automatically subscribe to notifications about the product or event. In some embodiments, the content is an advertisement. In some embodiments, the advertisement is for a movie, a new product release, a recreational event, a social event, an educational event, or a political event. In some embodiments, the electronic communications platform is Facebook, Instagram, or Twitter.

Disclosed herein, in some embodiments, are computer-implemented systems comprising: a digital processing device comprising: at least one processor, an operating system configured to perform executable instructions, a memory, and a computer program including instructions executable by the digital processing device to create an application for long-term, multi-stage user engagement comprising: (a) an interaction module identifying a user that has interacted with a link associated with content, wherein the identity of the user is known; (b) a flagging module storing the user's contact information and logging the user in a database of users for a follow-up communication; and (c) a re-engagement module automatically re-engaging with the user by sending the user a first message about the content via an interactive chat feature of an electronic communications platform. In some embodiments, the subject matter of the content comprises a date associated with an event. In some embodiments, the re-engagement module automatically provides further information about the event. In some embodiments, the re-engagement module is configured to allow the user to subscribe to notifications about the event. In some embodiments, the content is an advertisement. In some embodiments, the re-engagement module is configured to allow the user to engage with additional content. In some embodiments, the re-engagement module automatically re-engages with the user if the user responds to or interacts with the first message by sending the user a second message about the content via an interactive chat feature of an electronic communication platform. In some embodiments, the user is identified through a social platform. In some embodiments, the social platform is Facebook, Instagram, or Twitter. In some embodiments, the user interacts with the link through a touchscreen. In some embodiments, the user interacts with the link through a pointing device. In some embodiments, the user interacts with the link through a voice-based communication. In some embodiments, the content is an advertisement for a movie. In some embodiments, the content is an advertisement for a new product release. In some embodiments, the content is an advertisement for a sporting event. In some embodiments, the content is an advertisement for a concert.

Also disclosed herein, in some embodiments, are computer-implemented systems comprising: a digital processing device comprising: at least one processor, an operating system configured to perform executable instructions, a memory, and a computer program including instructions executable by the digital processing device to create an application for long-term, multi-stage user engagement comprising: (a) an interaction module identifying a user that has interacted with a link associated with content in a social platform, wherein the identity of the user is known; (b) a response module automatically responding to the interaction with a first message about the content via an interactive chat feature of an electronic communication platform; (c) a subscription module configured to allow the user to subscribe to notifications about the content; (d) a flagging module storing the user's contact information and logging the user in a database of users for a follow-up communication; and (e) a re-engagement module automatically re-engaging with the user by sending the user a second message about the content via an interactive chat feature of an electronic communication platform. In some embodiments, the subject matter of the content comprises a date associated with an event. In some embodiments, the re-engagement module automatically provides further information about the event. In some embodiments, the content is an advertisement. In some embodiments, the re-engagement module is configured to allow the user to engage with additional content. In some embodiments, the response module is configured to allow the user to engage with additional content. In some embodiments, the user is identified through a social platform. In some embodiments, the social platform is Facebook, Instagram, or Twitter. In some embodiments, the user interacts with the link through a touchscreen. In some embodiments, the user interacts with the link through a pointing device. In some embodiments, the user interacts with the link through a voice-based communication. In some embodiments, the content is an advertisement for a movie. In some embodiments, the content is an advertisement for a new product release. In some embodiments, the content is an advertisement for a sporting event. In some embodiments, the content is an advertisement for a concert.

Also disclosed herein, in some embodiments, are non-transitory computer-readable storage media encoded with a computer program including instructions executable by a processor to create a long-term, multi-stage user engagement response application comprising: (a) an interaction module identifying a user that has interacted with a link associated with content in a social platform, wherein the identity of the user is known; (b) a response module automatically responding to the interaction with a first message about the content via an interactive chat feature of an electronic communication platform; (c) a subscription module configured to allow the user to subscribe to notifications about the content; (d) a flagging module storing the user's contact information and logging the user in a database of users for a follow-up communication; and (e) a re-engagement module automatically re-engaging with the user by sending the user a second message about the content via an interactive chat feature of an electronic communication platform. In some embodiments, the subject matter of the content comprises a date associated with an event. In some embodiments, the re-engagement module automatically provides further information about the event. In some embodiments, the content is an advertisement. In some embodiments, the re-engagement module is configured to allow the user to engage with additional content. In some embodiments, the response module is configured to allow the user to engage with additional content. In some embodiments, the user is identified through a social platform. In some embodiments, the social platform is Facebook, Instagram, or Twitter. In some embodiments, the user interacts with the link through a touchscreen. In some embodiments, the user interacts with the link through a pointing device. In some embodiments, the user interacts with the link through a voice-based communication. In some embodiments, the content is an advertisement for a movie. In some embodiments, the content is an advertisement for a new product release. In some embodiments, the content is an advertisement for a sporting event. In some embodiments, the content is an advertisement for a concert.

Also disclosed herein, in some embodiments, are computer-implemented methods of long-term, multi-stage user engagement comprising: (a) identifying a user that has interacted with a link associated with content in a social platform, wherein the identity of the user is known; (b) automatically responding to the interaction with a first message about the content via an interactive chat feature of an electronic communication platform; (d) receiving a subscription from the user to receive future notifications about the content; (e) storing the user's contact information and logging the user in a database of users for a follow-up communication; and (f) automatically re-engaging with the user by sending the user a second message about the content via an interactive chat feature of an electronic communication platform. In some embodiments, the subject matter of the content comprises a date associated with an event. In some embodiments, the content is an advertisement. In some embodiments, the first message allows the user to engage with additional content. In some embodiments, the second message allows the user to engage with additional content. In some embodiments, the user is identified through a social platform. In some embodiments, the social platform is Facebook, Instagram, or Twitter. In some embodiments, the user interacts with the link through a touchscreen. In some embodiments, the user interacts with the link through a pointing device. In some embodiments, the user interacts with the link through a voice-based communication. In some embodiments, the content is an advertisement for a movie. In some embodiments, the content is an advertisement for a new product release. In some embodiments, the content is an advertisement for a sporting event. In some embodiments, the content is an advertisement for a concert.

### BRIEF DESCRIPTION OF THE DRAWINGS

A better understanding of the features and advantages of the present invention will be obtained by reference to the following detailed description that sets forth illustrative embodiments and the accompanying drawings of which:

FIG. 1 shows a non-limiting example of a process flow diagram; in this case, a diagram illustrating wherein the user interacts with a link directed to brand content and is automatically sent a follow-up communication;

FIG. 2 shows a non-limiting example of a process flow diagram; in this case, a diagram illustrating wherein the user interacts with an advertisement and is connected to a chat bot that automatically sends the user content of interest;

FIG. 3A and FIG. 3B show non-limiting examples of a process flow diagram; in this case, a diagram illustrating wherein the user interacts with a movie advertisement and is automatically sent content of interest; and

FIG. 4A, FIG. 4B, and FIG. 4C show non-limiting examples of an interactive chat interface initiated as described in further detail herein; in this case, an illustrative screenshot of an interactive electronic communications platform wherein the user interacts with a chat bot and is automatically sent content of interest.

FIG. 5 shows a non-limiting schematic diagram of a digital processing device; in this case, a device with one or more CPUs, a memory, a communication interface, and a display;

FIG. 6 shows a non-limiting schematic diagram of a web/mobile application provision system; in this case, a system providing browser-based and/or native mobile user interfaces; and

FIG. 7 shows a non-limiting schematic diagram of a cloud-based web/mobile application provision system; in this case, a system comprising an elastically load balanced, auto-scaling web server and application server resources as well synchronously replicated databases.

### DETAILED DESCRIPTION OF THE INVENTION

In one aspect, disclosed herein is computer-implemented system comprising: a digital processing device comprising: at least one processor, an operating system configured to perform executable instructions, a memory, and a computer program including instructions executable by the digital processing device to create an application for long-term, multi-stage user engagement comprising: an interaction module identifying a user that interacts with a link providing access to content, wherein the identity of the user on an electronic communications platform is known, and wherein the content is associated with a product or an event; a flagging module storing the user's contact information and logging the user in a database of users for a follow-up communication using the identity of the user on the electronic communications platform; and a re-engagement module automatically re-engaging with the user by sending the user a first message comprising additional content via an interactive chat feature of the electronic communications platform, wherein the additional content is associated with the product or the event. In some embodiments, the link is public or private. In some embodiments, the content or the additional content comprises a date associated with the product or the event. In some embodiments, the content or the additional content provides information of the product or the event. In some embodiments, the information is customized based on the identity of the user on the electronic communications platform. In some embodiments, the re-engagement module automatically re-engages with the user by sending the user the first message substantially instantaneously after the user interacts with the link. In some embodiments, the re-engagement module automatically re-engages with the user by sending the user the first message after a predetermined condition has been met. In some embodiments, the predetermined condition is a duration of time, a date, a time point, or onset of an event. In some embodiments, the interaction module allows the user to interact with the first message. In some embodiments, the re-engagement module further automatically re-engages with the user by sending the user a second message comprising further additional content associated with the product or the event. In some embodiments, the further additional content comprises a date associated with the product or the event. In some embodiments, the first message or the second message is private. In some embodiments, the re-engagement module automatically re-engages with the user by sending the second message substantially instantaneously after the user interacts with the first message. In some embodiments, the re-engagement module automatically re-engages with the user when a predetermined condition has been met after the first message has been sent. In some embodiments, the interaction module allows the user to interact with the second message. In some embodiments, the second message is sent via an interactive chat feature of the electronic communication platform or a second electronic communication platform. In some embodiments, the further additional content provides specific features of the product or the event that is only available to the user after the user interacts with the first message, the second message, or both. In some embodiments, the user interaction with the link, first message, or second message is via an input device. In some embodiments, the input device comprises one or more of: a touchscreen, a keyboard, a pointing device, a camera, and a microphone. In some embodiments, the re-engagement module allows the user to subscribe to notifications about the product or event. In some embodiments, the first message or the second message comprises access allowing the user to automatically subscribe to notifications about the product or event. In some embodiments, the content is an advertisement. In some embodiments, the advertisement is for a movie, a new product release, a recreational event, a social event, an educational event, or a political event. In some embodiments, the electronic communications platform is Facebook, Instagram, or Twitter. In some embodiments, the system herein further comprises a response module automatically responding to the interaction with a first message about the content via an interactive chat feature of an electronic communication platform. In some embodiments, the system herein further comprises a subscription module configured to allow the user to subscribe to notifications about the content.

In another aspect, disclosed herein is a computer-implemented system comprising: a digital processing device comprising: at least one processor, an operating system configured to perform executable instructions, a memory, and a computer program including instructions executable by the digital processing device to create an application for long-term, multi-stage user engagement comprising: an interaction module identifying a user that interacts with a link providing access to content, wherein the identity of the user on an electronic communications platform is known, and wherein the content is associated with a product or an event; a response module automatically responding to the interaction with a first message comprising additional content via an interactive chat feature of the electronic communication platform, the additional content associated with the product or event; a subscription module configured to allow the user to subscribe to notifications about the content; a flagging module storing the user's contact information and logging the user in a database of users for a follow-up communication using the identity of the user on the electronic communications platform; and a re-engagement module automatically re-engaging with the user by sending the user a second message comprising further additional content via an interactive chat feature of the electronic communications platform, wherein the further additional content is associated with the product or the event. In some embodiments, the subscription module is configured to allow the user to subscribe to notifications about the content is via the first message or the second message. In some embodiments, the subscription module is configured to allow the user to subscribe to notifications about the content does not require manual input of user's contact information. In some embodiments, the notifications about the content are within the electronic communication platform. In some embodiments, the link, the first message, or the second message is public or private. In some embodiments, the content, the additional content, or the further additional content comprises a date associated with the product or the event. In some embodiments, the additional content, or the further additional content provides information of the product or the event. In some embodiments, the information is customized based on the identity of the user on the electronic communications platform. In some embodiments, the first message is sent substantially instantaneously after the user interacts with the link. In some embodiments, the first message is sent after a predetermined condition has been met. In some embodiments, the predetermined condition is a duration of time, a date, a time point, or onset of an event. In some embodiments, the interaction module allows the user to interact with the first message, the second, message, or both. In some embodiments, the re-engagement module automatically re-engages with the user by sending the second message substantially instantaneously after the user interacts with the first message. In some embodiments, the re-engagement module automatically re-engages with the user when a predetermined condition has been met after the first message has been sent. In some embodiments, the second message is sent via an interactive chat feature of the electronic communication platform or a second electronic communication platform. In some embodiments, the further additional content provides specific features of the product or the event that is only available to the user after the user interacts with the first message, the second message, or both. In some embodiments, the user interaction with the link, first message, or second message is via an input device. In some embodiments, the input device comprises one or more of: a touchscreen, a keyboard, a pointing device, a camera, and a microphone. In some embodiments, the first message or the second message comprises access allowing the user to automatically subscribe to notifications about the product or event. In some embodiments, the content is an advertisement. In some embodiments, the advertisement is for a movie, a new product release, a recreational event, a social event, an educational event, or a political event. In some embodiments, the electronic communications platform is Facebook, Instagram, or Twitter.

In another aspect, disclosed herein is non-transitory computer-readable storage media encoded with a computer program including instructions executable by a processor to create a long-term, multi-stage user engagement response application comprising: an interaction module identifying a user that interacts with a link providing access to content, wherein the identity of the user on an electronic communications platform is known, and wherein the content is associated with a product or an event; a response module automatically responding to the interaction with a first message comprising additional content via an interactive chat feature of the electronic communication platform, the additional content associated with the product or event; a subscription module configured to allow the user to subscribe to notifications about the content; a flagging module storing the user's contact information and logging the user in a database of users for a follow-up communication using the identity of the user on the electronic communications platform; and a re-engagement module automatically re-engaging with the user by sending the user a second message comprising further additional content via an interactive chat feature of the electronic communications platform, wherein the further additional content is associated with the product or the event. In some embodiments, the subscription module is configured to allow the user to subscribe to notifications about the content is via the first message or the second message. In some embodiments, the subscription module is configured to allow the user to subscribe to notifications about the content does not require manual input of user's contact information. In some embodiments, the notifications about the content are within the electronic communication platform. In some embodiments, the link, the first message, or the second message is public or private. In some embodiments, the content, the additional content, or the further additional content comprises a date associated with the product or the event. In some embodiments, the additional content, or the further additional content provides information of the product or the event. In some embodiments, the information is customized based on the identity of the user on the electronic communications platform. In some embodiments, the first message is sent substantially instantaneously after the user interacts with the link. In some embodiments, the first message is sent after a predetermined condition has been met. In some embodiments, the predetermined condition is a duration of time, a date, a time point, or onset of an event. In some embodiments, the interaction module allows the user to interact with the first message, the second, message, or both. In some embodiments, the re-engagement module automatically re-engages with the user by sending the second message substantially instantaneously after the user interacts with the first message. In some embodiments, the re-engagement module automatically re-engages with the user when a predetermined condition has been met after the first message has been sent. In some embodiments, the second message is sent via an interactive chat feature of the electronic communication platform or a second electronic communication platform. In some embodiments, the further additional content provides specific features of the product or the event that is only available to the user after the user interacts with the first message, the second message, or both. In some embodiments, the user interaction with the link, first message, or second message is via an input device. In some embodiments, the input device comprises one or more of: a touchscreen, a keyboard, a pointing device, a camera, and a microphone. In some embodiments, the first message or the second message comprises access allowing the user to automatically subscribe to notifications about the product or event. In some embodiments, the content is an advertisement. In some embodiments, the advertisement is for a movie, a new product release, a recreational event, a social event, an educational event, or a political event. In some embodiments, the electronic communications platform is Facebook, Instagram, or Twitter.

In yet another aspect, disclosed herein is a computer-implemented method of long-term, multi-stage user engagement comprising: identifying a user that interacts with a link providing access to content, wherein the identity of the user on an electronic communications platform is known, and wherein the content is associated with a product or an event; automatically responding to the interaction with a first message comprising additional content via an interactive chat feature of an electronic communication platform, the additional content associated with the product or event; receiving a subscription from the user to receive future notifications about the content; storing the user's contact information and logging the user in a database of users for a follow-up communication using the identity of the user on the electronic communications platform; and automatically re-engaging with the user by sending the user a second message comprising further additional content via an interactive chat feature of an electronic communication platform, wherein the further additional content is associated with the product or the event. In some embodiments, the subscription module is configured to allow the user to subscribe to notifications about the content is via the first message or the second message. In some embodiments, the subscription module is configured to allow the user to subscribe to notifications about the content does not require manual input of user's contact information. In some embodiments, the notifications about the content are within the electronic communication platform. In some embodiments, the link, the first message, or the second message is public or private. In some embodiments, the content, the additional content, or the further additional content comprises a date associated with the product or the event. In some embodiments, the additional content, or the further additional content provides information of the product or the event. In some embodiments, the information is customized based on the identity of the user on the electronic communications platform. In some embodiments, the first message is sent substantially instantaneously after the user interacts with the link. In some embodiments, the first message is sent after a predetermined condition has been met. In some embodiments, the predetermined condition is a duration of time, a date, a time point, or onset of an event. In some embodiments, the interaction module allows the user to interact with the first message, the second, message, or both. In some embodiments, the re-engagement module automatically re-engages with the user by sending the second message substantially instantaneously after the user interacts with the first message. In some embodiments, the re-engagement module automatically re-engages with the user when a predetermined condition has been met after the first message has been sent. In some embodiments, the second message is sent via an interactive chat feature of the electronic communication platform or a second electronic communication platform. In some embodiments, the further additional content provides specific features of the product or the event that is only available to the user after the user interacts with the first message, the second message, or both. In some embodiments, the user interaction with the link, first message, or second message is via an input device. In some embodiments, the input device comprises one or more of: a touchscreen, a keyboard, a pointing device, a camera, and a microphone. In some embodiments, the first message or the second message comprises access allowing the user to automatically subscribe to notifications about the product or event. In some embodiments, the content is an advertisement. In some embodiments, the advertisement is for a movie, a new product release, a recreational event, a social event, an educational event, or a political event. In some embodiments, the electronic communications platform is Facebook, Instagram, or Twitter.

Disclosed herein, in some embodiments, are computer-implemented systems comprising: a digital processing device comprising: at least one processor, an operating system configured to perform executable instructions, a memory, and a computer program including instructions executable by the digital processing device to create an application for long-term, multi-stage user engagement comprising: (a) an interaction module identifying a user that has interacted with a link associated with content, wherein the identity of the user is known; (b) a flagging module storing the user's contact information and logging the user in a database of users for a follow-up communication; and (c) a re-engagement module automatically re-engaging with the user by sending the user a first message about the content via an interactive chat feature of an electronic communications platform.

Also disclosed herein, in some embodiments, are computer-implemented systems comprising: a digital processing device comprising: at least one processor, an operating system configured to perform executable instructions, a memory, and a computer program including instructions executable by the digital processing device to create an application for long-term, multi-stage user engagement comprising: (a) an interaction module identifying a user that has interacted with a link associated with content in a social platform, wherein the identity of the user is known; (b) a response module automatically responding to the interaction with a first message about the content via an interactive chat feature of an electronic communication platform; (c) a subscription module configured to allow the user to subscribe to notifications about the content; (d) a flagging module storing the user's contact information and logging the user in a database of users for a follow-up communication; and (e) a re-engagement module automatically re-engaging with the user by sending the user a second message about the content via an interactive chat feature of an electronic communication platform.

Further disclosed herein, in some embodiments, are non-transitory computer-readable storage media encoded with a computer program including instructions executable by a processor to create a long-term, multi-stage user engagement response application comprising: (a) an interaction module identifying a user that has interacted with a link associated with content in a social platform, wherein the identity of the user is known; (b) a response module automatically responding to the interaction with a first message about the content via an interactive chat feature of an electronic communication platform; (c) a subscription module configured to allow the user to subscribe to notifications about the content; (d) a flagging module storing the user's contact information and logging the user in a database of users for a follow-up communication; and (e) a re-engagement module automatically re-engaging with the user by sending the user a second message about the content via an interactive chat feature of an electronic communication platform.

Also disclosed herein, in some embodiments, are computer-implemented methods of long-term, multi-stage user engagement comprising: (a) identifying a user that has interacted with a link associated with content in a social platform, wherein the identity of the user is known; (b) automatically responding to the interaction with a first message about the content via an interactive chat feature of an electronic communication platform; (d) receiving a subscription from the user to receive future notifications about the content; (e) storing the user's contact information and logging the user in a database of users for a follow-up communication; and (f) automatically re-engaging with the user by sending the user a second message about the content via an interactive chat feature of an electronic communication platform.

### Certain Definitions

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

In some embodiments, the “link” herein is a hyper link or any other reference that points to data that the reader can directly follow either by interacting with the link using an input device, e.g., by clicking, tapping, or hovering. A link herein can point to a whole document, a media, or to a specific element within a document or media.

In some embodiments, the “electronic communications platform” may include software, computer program, web application, mobile application or any other tools that allow messaging, chatting, blogging, or otherwise electronic communication among users. In some embodiments, the “electronic communications platform” is a social networking platform. In some embodiments, each user of the platform has a unique identification associated therewith. In some embodiments, the platform allows private messaging and/or chatting. As examples, the electronic communications platform is Facebook/Facebook Messenger, Instagram, Snapchat, MSN messenger, Google Hangouts, Viber, Slack, WeChat, WhatsApp, and/or Twitter.

### Modules

In some embodiments, the systems, methods, and media herein include one or more of: an interaction module, flagging module, re-engagement module, response module, subscription module, and other modules. As disclosed herein, the modules herein are software alone or in combination with hardware elements (e.g., CPU, digital processing device, processor, etc.) to perform highly specific functions disclosed herein. The modules herein can include but is not limited to: software modules, computer programs, algorithms, and graphical user interfaces.

In some embodiments, the interaction module is configured to identify a user and/or a user's interaction with a link. In some embodiments, the user is logged in in at least one electronic communications platform when the user interacts with the link. In some embodiments, the link is specifically provided to a user of an electronic communications platform. The interaction module may collect information re the user's status on the electronic communications platform for identification of the user. Other information that can be used to uniquely identify the user, e.g., the user's IP address, may be alternatively used or used in combination. In some embodiments, the interaction module may communicate with a central database or management system of the electronic communications platform to obtain identity information of the user.

In some embodiments, the information containing the user's identify determined by the interaction module may be passed on to a flagging module so that the flagging module can store the user's contact information and logging the user in a database of users for a follow-up communication. In some embodiments, the information stored by the flagging module may include one or more of: a unique representation of the user's identity, additional information associated with the user's identity (such as the user's location, age, gender, etc.) a date, a time, the link that the user interacted with, the content associated with link, follow-up time, follow up time, additional content for follow-up.

In some embodiments, the flagging module is configured to derive a specific plan for the follow-up communication based on the stored information of the user. For example, if the user interacted with the link for a couple of times (e.g., interacted with the link at least 2 times, at least 3 times, at least 4 times, or some other condition number of interactions), the flagging module may flag the user as being strongly interested in the content of the link and may follow-up with the user with additional content related to the content of the link automatically and frequently with the user. In some embodiments, the information stored by the flagging module may be used by one or more modules herein for re-engagement or follow-up communication.

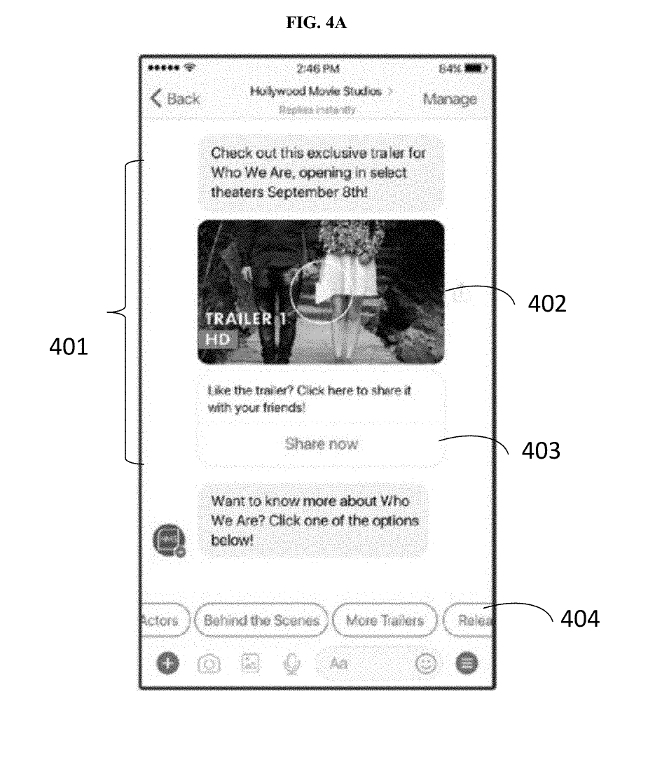

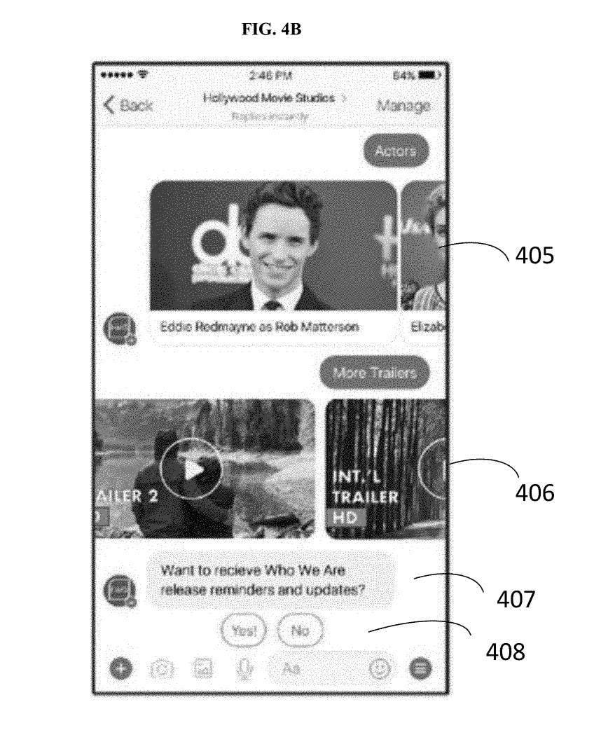

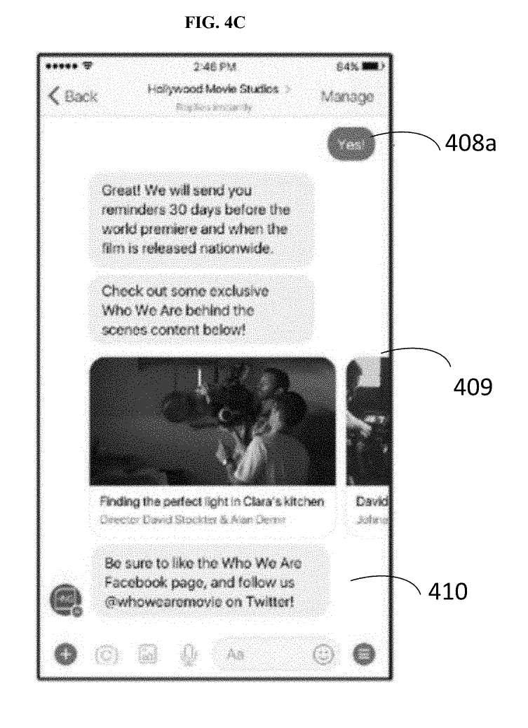

In some embodiments, the response module automatically responds to the interaction of the user using a first message about the content via an interactive chat feature of an electronic communication platform. In some embodiments, the response module uses the user's identity on the electronic communications platform, and sends an automatic message to the user via an interactive chat feature. In some embodiments, the interactive chat feature is a chat bot that may intelligently chat with the user. In some embodiments, the interactive chat feature or the first message is private. In some embodiments, the interactive chat feature or the first message includes one or more of text, image(s), link(s), video(s), and/or audio information. In some embodiments, the interactive chat feature or the first message allows access to additional text, images, links, video, and/or audio information that is only available to the user after the user interacts with the interactive chat feature or the first message, e.g. 404, 407 in FIGS. 4A-4B.

In some embodiments, the subscription module is configured to allow the user to subscribe to notifications about the content. In some embodiments, the user may easily and conveniently interact with the subscription module to subscribe to notifications. In some embodiments, the user interaction does not include manual input of the user's contact information, such as address, phone number or email address. For example, the user's interaction may include clicking “yes” 408 in FIG. 4B to subscribe. Afterwards, the user's contact information can be obtained from the database and used for sending notifications.

In some embodiments, a re-engagement module automatically re-engages with the user by sending the user a second message about the content via an interactive chat feature of an electronic communication platform. In some embodiments, the notifications are sent directly within the electronic communications platform. For example, a chat bot in Facebook may automatically send notifications to the user after the user's subscription. In some embodiments, the second message is private. In some embodiments, the second message allows access to additional text, images, links, video, and/or audio information that is only available to the user after the user interacts with the interactive chat feature. In some embodiments, the interactive chat feature is private. In some embodiments, the interactive chat feature includes one or more of text, image(s), link(s), video(s), and/or audio information.

### Links and Messages

In some embodiments, the interactive chat feature is intelligent so that additional messages may be intelligently generated after the second message based on the user's interaction with the interactive chat feature. In some embodiments, the interactive chat feature uses machine learning algorithms to communicate with and/or respond to the user's interaction(s).

In some embodiments, the systems and methods described herein may use machine learning algorithms for training prediction models and/or making predictions for communication with the user. Machine learning algorithms herein may learn from and make predictions on data. Data may be any input, intermediate output, previous outputs, or training information, or otherwise any information provided to or by the algorithms. For example, the data may be the user's previous interaction with the interactive chat feature or any other features of the electronic communications platform.

A machine learning algorithm may use a supervised learning approach. In supervised learning, the algorithm can generate a function or model from training data. The training data can be labeled. The training data may include metadata associated therewith. Each training example of the training data may be a pair consisting of at least an input object and a desired output value. A supervised learning algorithm may require the user to determine one or more control parameters. These parameters can be adjusted by optimizing performance on a subset, for example a validation set, of the training data. After parameter adjustment and learning, the performance of the resulting function/model can be measured on a test set that may be separate from the training set. Regression methods can be used in supervised learning approaches.

A machine learning algorithm may use an unsupervised learning approach. In unsupervised learning, the algorithm may generate a function/model to describe hidden structures from unlabeled data (i.e., a classification or categorization that cannot be directed observed or computed). Since the examples given to the learner are unlabeled, there is no evaluation of the accuracy of the structure that is output by the relevant algorithm. Approaches to unsupervised learning include: clustering, anomaly detection, and neural networks.

A machine learning algorithm may use a semi-supervised learning approach. Semi-supervised learning can combine both labeled and unlabeled data to generate an appropriate function or classifier.

A machine learning algorithm may use a reinforcement learning approach. In reinforcement learning, the algorithm can learn a policy of how to act given an observation of the world. Every action may have some impact in the environment, and the environment can provide feedback that guides the learning algorithm.

A machine learning algorithm may use a transduction approach. Transduction can be similar to supervised learning, but does not explicitly construct a function. Instead, tries to predict new outputs based on training inputs, training outputs, and new inputs.

A machine learning algorithm may use a “learning to learn” approach. In learning to learn, the algorithm can learn its own inductive bias based on previous experience.

A machine learning algorithm is applied to user data to generate a prediction model. In some embodiments, a machine learning algorithm or model may be trained periodically. In some embodiments, a machine learning algorithm or model may be trained non-periodically.

As used herein, a machine learning algorithm may include learning a function or a model. The mathematical expression of the function or model may or may not be directly computable or observable. The function or model may include one or more parameter(s) used within a model. For example, a linear regression model having a formula Y=C0+C1×1+C2×2 has two predictor variables, x1 and x2, and coefficients or parameter, C0, C1, and C2. The predicted variable in this example is Y. After the parameters of the model are learned, values can be entered for each predictor variable in a model to generate a result for the dependent or predicted variable (e.g., Y).

In some embodiments, the content, additional content, or further additional content herein is an advertisement, a movie trailer, a multimedia game, an audio clip, a video clip. In some embodiments, the content, additional content, or further additional content is associated with for a movie, a new product release, a recreational event, a social event, an educational event, or a political event.

In some embodiments, the link, the first message, and/or the second message herein includes text, audio, video, graphical information, or access to additional information.

In some embodiments, the link, the first message, and the second message contain different information associated with the product or the event.

In some embodiments, the additional content in the first message is generated based on the content provided in the link. For example, the additional content may include more detail about the product or event than the content provided via the link Similarly, the further additional content in the second message can be generated based on the content provided in the first message. For example, the further additional content may include more detail, more insight about the product or event than the content provided via the first message. For example, the link may provide access to one movie trailer while the first message may provide access to actors, and more different movie trailers.

In some embodiments, the systems, methods, or media herein automatically send a message substantially instantaneously after the user interacts with the link or a previous message. In some embodiments, when the message is sent substantially instantaneously after the user's interaction, the user is unable to perceive the delay between their interaction and the message sent thereafter. In some embodiments, substantially instantaneously includes a delay of less than 0.1 second, 0.5 second, 1 second, 1.2 seconds, 1.5 seconds, 2 seconds, or 3 seconds. In some embodiments, the message is sent after a predetermined condition has been met. In some embodiments, the predetermined condition is a duration of time, a date, a time point, or onset of an event. For example, the system or methods herein may automatically send a subsequent follow-up message with updated content every 24 hours after sending a first message or after the user has interacted with the link or the first message. As another example, the systems or methods herein may automatically send a subsequent follow-up message when any update becomes available regarding the product or the event. As yet another example, the systems or methods herein may automatically send a subsequent follow-up message after a movie premier has occurred or a product has been released.

In some embodiments, the content of the follow-up message and the first message are generated by the systems and methods herein, for example, customized to include information that the user may be interested in.

### Long-Term, Multi-Stage User Engagement

In some embodiments, the platforms, systems, media, and methods described herein include features for the automatic, long-term, multi-stage engagement of users from the provision of a single link.

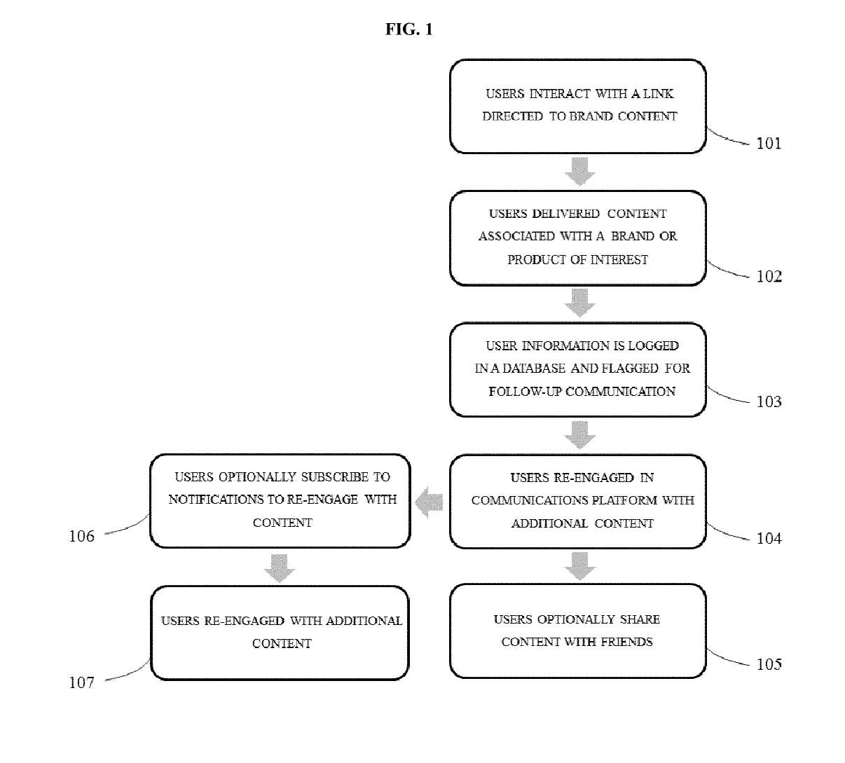

Referring to FIG. 1, in some embodiments, a user interacts with a link directed to content 101 surrounding a brand or product, where the identity of the user is known. In some embodiments, the identity of the user is known or determined from profile information in or derived from online or mobile communications platforms. In some embodiments, the identity of the user is known or determined from profile information in or derived from social platforms such as Facebook, Instagram, or Twitter. In some embodiments, the identity of the user is known by obtaining information of the computer that the user is using to interact with the link, e.g., a unique IP address. In some embodiments, the user interacts with a link directed to content 101 surrounding a brand or product in a web browser, mobile web browser, or web/mobile application. In some embodiments, the user interacts with a link directed to content 101 surrounding a brand or product in a social platform feed in a web/mobile browser or web/mobile application. In some embodiments, the user interacts with a link directed to content 101 surrounding a brand or product in Facebook, Instagram, or Twitter feed in a web browser, mobile web browser, or web/mobile application. In some embodiments, the user interacts with the content 101 with an input device. For example, in some embodiments, the user interacts with the content 101 by clicking on a link with a pointing device. In some embodiments, the user interacts with the content 101 with a touchscreen. In some embodiments, the user interacts with the content 101 using a voice interface.

With continued reference to FIG. 1, in some embodiments, upon interacting with a link directed to brand content 101, the user is delivered content associated with a brand or product of interest 102. In some embodiments, the brand content is information about a commercial product or event. In some embodiments, the brand content is information about a commercial product or event associated with a date in the future. In some embodiments, the brand content is a movie trailer. In some embodiments, the brand content is a product announcement. In some embodiments, the brand content is information about a sporting event. In some embodiments, the brand content is information about a concert. In some embodiments, the brand content is news or other public disclosure of a product or an event. In some embodiments, the brand content is a commercial advertisement of a product or an event.

With continued reference to FIG. 1, in some embodiments, upon content delivery 102, or alternatively or in combination, upon user's interaction with the brand content, user information is logged in a database and flagged for a follow-on communication 103. In some embodiments, such follow-on communication is via an interactive chat feature of an electronic communications platform. As examples, the electronic communications platform is Facebook/Facebook Messenger, Instagram, Snapchat, MSN messenger, Google Hangouts, Viber, Slack, WeChat, WhatsApp, or Twitter. Following database logging 103, the user is automatically re-engaged (e.g., by a chat bot) via an interactive chat feature of an electronic communications platform, and additional content or information is delivered to the user 104. In some embodiments, the additional content or information is based on, or otherwise related to the content delivered in 102. In some embodiments, the additional content or information is a reminder of the content delivered in 102. By way of non-limiting example, if the user is flagged 103 after content delivery associated with a brand's product 102, the re-engagement communication 104 is an electronic communications platform message (e.g., Facebook Messenger) reminding the user of their interest in the product. Continuing this example, in some embodiments, the re-engagement communication 104 is a message such as: (1) “Have you purchased [product] yet?” or “[Product] is on sale at [store] for a limited time only!” Alternatively, in some embodiments, the re-engagement communication 104 is an electronic communications platform message (e.g., Facebook Messenger) providing additional content surrounding the product (e.g., an image or video of the product) logged 103 to be of interest to the user. In some embodiments, the re-engagement communication 104 provides an option for the user to subscribe to notifications surrounding the brand or product 106; whereby the user will automatically engaged with further electronic communications platform messages that are of interest to the user. In some embodiments, the re-engagement communication 104 provides an option for the user to automatically receive additional content related to the brand or product of initial interest. In some embodiments, the additional content are “special features” (e.g., behind the scenes video of a movie) that can only be accessed after primary content delivery 102. In some embodiments, the re-engagement communication 104 occurs once, twice, three or even more times automatically without the need for the user to interact with the re-engagement communication with an input device. Each time the re-engagement communication may or may not be identical in order to re-engage the user to the product or event 102. For example, a second re-engagement communication can be automatically generated after a time period passed since the first re-engagement communication or after a condition has been met after the first re-engagement communication. An exemplary re-engagement communication that appears after the first re-engagement communication is a message such as: The concert for Jul. 4^{th} is sold out, act fast to book your seat for the concert on Jul. 11^{th}.

In some embodiments, the re-engagement communication 104 provides an option for the user to automatically share the content with one or more contacts using an online or mobile communications platform 105. If a user chooses to share the content with one or more of their contacts, a message containing the shared content is automatically delivered via an electronic communications platform message. In some embodiments, the user optionally shares the content 106 using social platforms such as Facebook, Instagram, or Twitter. The ability to immediately share information about brand content across multiple users from a single user's interaction with a single link results in additional acquired users and return on investment from the originating link.

With continued reference to FIG. 1, in some embodiments, upon interacting with a link directed to brand content 101, the user is automatically directed to an electronic communications platform and delivered content associated with a brand or product of interest 102. For example, in some embodiments, a user interacts with a link containing content directed to a product or brand of interest in a Facebook or Instagram feed and is automatically sent a private Facebook Messenger message providing the desired content. Continuing this example, once the content is delivered, the user is automatically given options to (1) automatically receive notifications (e.g., additional messages) of further/new content or information about the brand or product; (2) receive additional content or information about other brands or products potentially of interest to the user; and/or (3) share the delivered content with one or more social platform contacts.

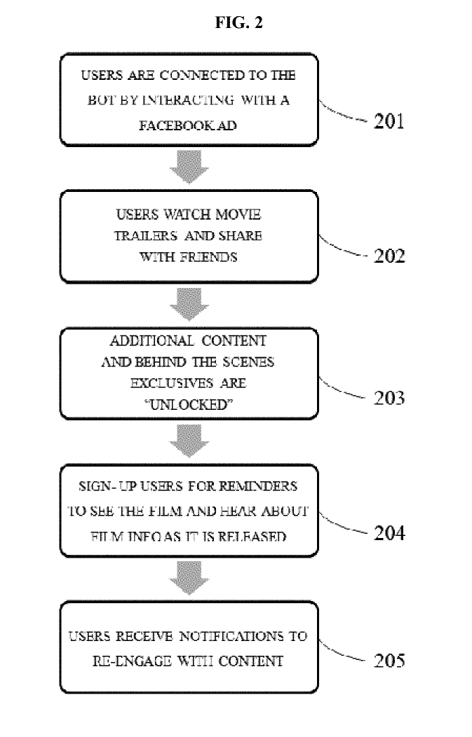

Referring to FIG. 2, in some embodiments, a user is connected to an automated chat bot by interacting with a link, e.g., a Facebook advertisement directed to, e.g., a movie trailer 201. Upon interacting with the link, the chat bot automatically sends an interactive communication platform message (e.g., Facebook Messenger) message by the chat bot providing the desired trailer and giving the user the option to automatically share the trailer with one or more of the user's social platform contacts 202. Upon interacting with the link and receiving the movie trailer, the user is automatically given the option to view additional content (e.g., behind-the scenes exclusives) 203. In some embodiments, the additional content 203 is only available after the user has connected to the chat bot 201. Upon interacting with the link and receiving the movie trailer, the user is automatically given the option to subscribe to future notifications surrounding the content 204. Upon signing-up to receive additional content, the chat bot will automatically send one or more additional messages to the user at a later time or date 205. For example, upon subscribing to additional content surrounding the movie 204, the chat bot automatically sends the user 205: (1) the newest trailer once it is released; (2) a reminder about the premiere date of the movie; and/or (3) links to locations were movie tickets can be purchased.

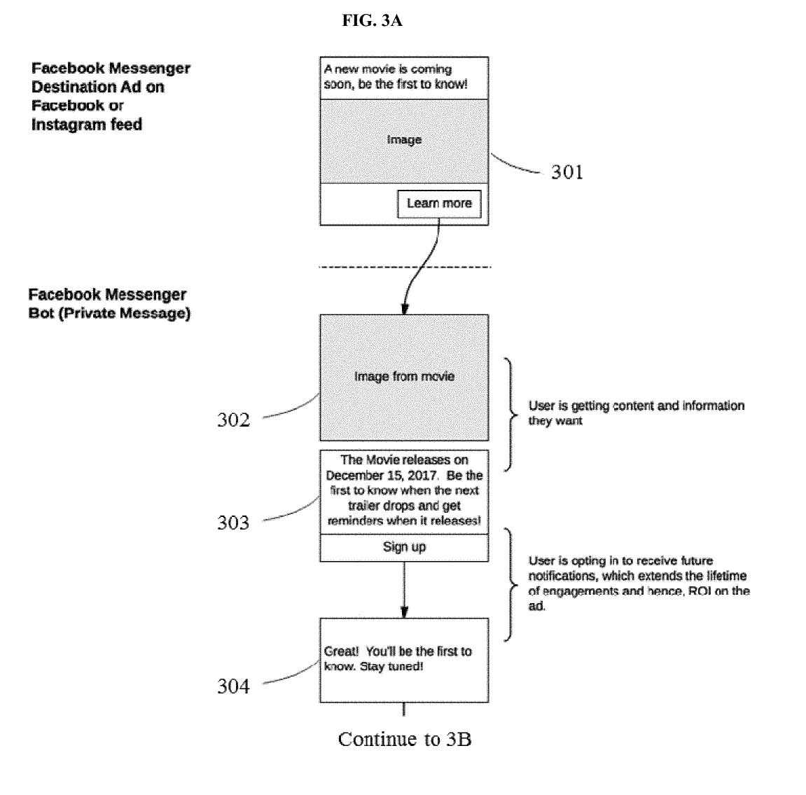

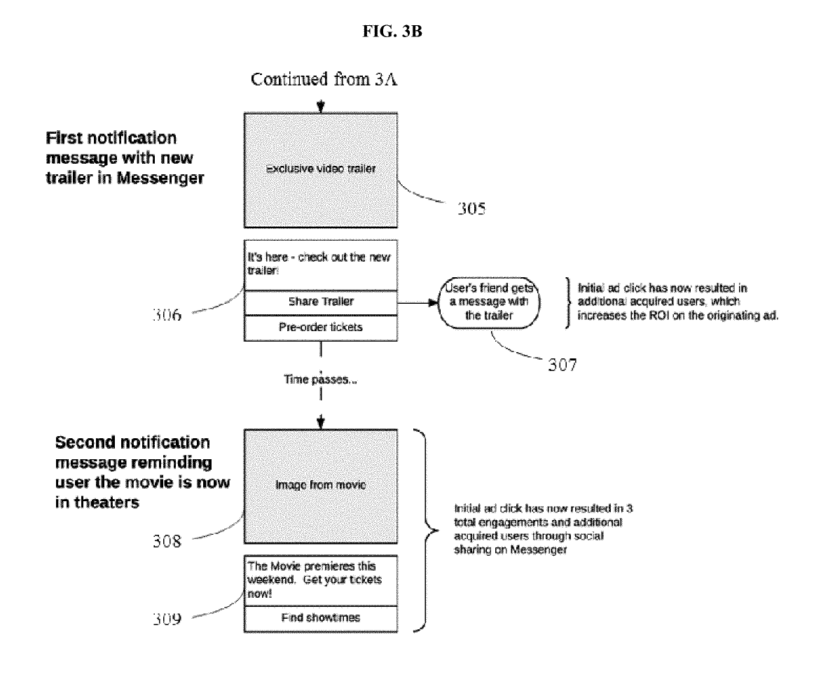

Referring to FIG. 3A, in some embodiments, a user is presented with a link, e.g., a Facebook messenger destination advertisement in a Facebook or Instagram feed in which the user is offered additional content to a brand, product, or event. For example, the user is presented with an advertisement stating “A new movie is coming soon, be the first to know!” as well as an image of the movie designed or customized to attract the interest of the user 301. If the content of the image is of interest to the user, the user can access another link to additional content; in this example, the user is offered to “Learn more” about the movie by interacting with a link that automatically sends the user a private Facebook Messenger message. In some embodiments, the link is private so that only the user with the Facebook account can see it. In some embodiments, the link is public so that multiple users can view it, e.g., on the Facebook website before a user logs in.

With continued reference to FIG. 3A, upon interacting with the link to additional content (e.g., “Learn more” link), the user is automatically sent a private Facebook Messenger message comprising an image from the movie 302 and information about movie release date 303. In some embodiments, the user is given the option to subscribe to future notifications surrounding the movie and automatically be sent an additional message with content or information about the movie. For example, the user could subscribe (e.g., a “Sign up” link 303) and opt-in automatically receive future notifications about the newest trailer once it is released or a reminder about the premiere date of the movie. If the user subscribes to future notifications, the user's subscription is automatically confirmed 304 and the user is flagged for re-engagement. The ability to allow users to opt-in to receive future notifications about brand content from a single interaction with a single link extend the lifetime of the engagements with the user resulting in additional return on investment from the originating link.

The embodiments of FIG. 3A are continued in FIG. 3B. After the user has subscribed to receive future notifications, the user is automatically sent additional content at a predetermined date in the future or is automatically sent new content when available. With continued reference to FIG. 3B, once available for release, the user is automatically sent a Facebook Messenger message containing a video trailer of the movie of interest 305. Additionally, in some embodiments, the user is given the option to automatically share the trailer (e.g., a “Share Trailer” link) 306 with one or more of the user's social platform contacts or order tickets prior to the release of the movie (e.g., a “Pre-order tickets” link) 306. With continued reference to FIG. 3B, once the movie is close to release, the user is automatically sent an additional Facebook Messenger message containing an image reminding the user of the movie of interest 308 and giving the user the option to automatically find additional relevant information about the move premiere (e.g., a “Find showtimes” link) 309. In the embodiments represented by FIGS. 3A-B, a single link interaction results in 3 total engagements and additional acquired users through social platform sharing on Facebook Messenger, thereby dramatically increasing advertising effectiveness, user engagement, and return on investment.

Referring to FIG. 4A, in a particular embodiment, a user is presented with a Facebook messenger destination advertisement 401 in a Facebook or Instagram feed in which the user is offered additional content to a brand, product, or event. For example, the user is presented with a link 402 to the trailer of the movie “Who We Are.” See generally FIGS. 4A-C. With reference to FIG. 4A, when a user interacts with the “Who We Are” link, the user is automatically connected to a chat bot and sent a social platform interactive message (e.g., Facebook Messenger message) providing the desired trailer and offering additional information about the movie, such as the movie premiere date. With continued reference to FIG. 4A, in some embodiments, the user is given the option to automatically share the trailer 403 (e.g., a “Share now” link) with one or more of the user's social platform contacts. Additionally, in some embodiments, the chat bot automatically presents the user with options to automatically obtain additional content about the movie or to watch additional trailers of potential interest to the user 404.

The embodiments of FIG. 4A are continued in FIG. 4B. Temporarily referring back to FIG. 4A, in some embodiments, the user is given the option 404 to: (1) find information about the actors in the movie (e.g., an “Actors” link); (2) gain access to behind-the-scenes videos (e.g., a “Behind the Scenes” link); (3) gain access to additional movie trailers (e.g., a “More Trailers” link); and/or (4) find information about the release date of the movie (e.g., a “Release Date” link). In each of these aforementioned situations, in response to a user's interaction with the additional links, the chat bot automatically provides the additional requested content in the interactive chat interface. With reference to FIG. 4B, if the user is interested in information about the actors of “Who We Are”, the user interacts with the “Actors” link 404 and the chat bot provides the requested information (e.g., “Eddie Redmayne as Rob Matterson”) as well as images of the actors 405. With continued reference to FIG. 4B, if the user is interested in viewing additional “Who We Are” trailers, the user either interacts with the “More Trailers” link or sends a “More Trailers” message to the chat bot 404. Upon receiving the “More Trailers” message, the chat bot provides additional “Who We Are” trailers for the user to view 406. With continued reference to FIG. 4B, in some embodiments, the user is given the option to subscribe to future notifications surrounding “Who We Are” and automatically be sent additional message with content or information about the movie. For example, the chat bot asks the user 407, “Want to receive Who We Are release reminders and updates?” The user can then interact with the “Yes!” or “No” links 408 (or send an equivalent chat message) 408a to indicate their preference for future notifications.

The embodiments of FIG. 4B are continued in FIG. 4C. With reference to FIG. 4C, if the user subscribes for “release reminders and updates” (see FIG. 4B), the chat bot will automatically confirm the subscription and flag the user in a database for follow-up communications. In some embodiments, after subscribing to additional notifications, the user is given access to exclusive “Who We Are” content 409 and 410, such as behind the scenes videos.

In some of the aforementioned embodiments, the user interacts with the chat bot by typing and sending messages for the requested action into the interactive communications platform (e.g., in FIG. 4B, the user types and sends the word “Actors” to automatically be sent information about the actors of “Who We Are”). In some embodiments, when the user interacts with the links to additional content (e.g., in FIG. 4A, the “Actors” or “Behind the Scenes” options), a message is automatically typed and sent in the interactive communications platform to the chat bot for the requested action (e.g., in FIG. 4B, the user interacts with the “Actors” link (e.g., touches on a touchscreen) to automatically send an “Actors” message in the interactive communications platform (e.g., Facebook Messenger) to the chat bot. In some embodiments, the user interacts with the chat bot using an input device. The interaction can be text, image, audio, video, and/or any other type of interactions. For example, the user may shake his phone to indicate his interests in receiving release reminders and updates.

### Digital Processing Device

In some embodiments, the platforms, systems, media, and methods described herein include a digital processing device, or use of the same. In further embodiments, the digital processing device includes one or more hardware central processing units (CPUs) or general purpose graphics processing units (GPGPUs) that carry out the device's functions. In still further embodiments, the digital processing device further comprises an operating system configured to perform executable instructions. In some embodiments, the digital processing device is optionally connected to a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, media streaming devices, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®. Those of skill in the art will also recognize that suitable media streaming device operating systems include, by way of non-limiting examples, Apple TV®, Roku®, Boxee®, Google TV®, Google Chromecast®, Amazon Fire®, and Samsung® HomeSync®. Those of skill in the art will also recognize that suitable video game console operating systems include, by way of non-limiting examples, Sony® PS3®, Sony® PS4®, Microsoft® Xbox 360®, Microsoft Xbox One, Nintendo® Wii®, Nintendo® Wii U®, and Ouya®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In yet other embodiments, the display is a head-mounted display in communication with the digital processing device, such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera or other sensor to capture motion or visual input. In further embodiments, the input device is a Kinect, Leap Motion, or the like. In still further embodiments, the input device is a combination of devices such as those disclosed herein.

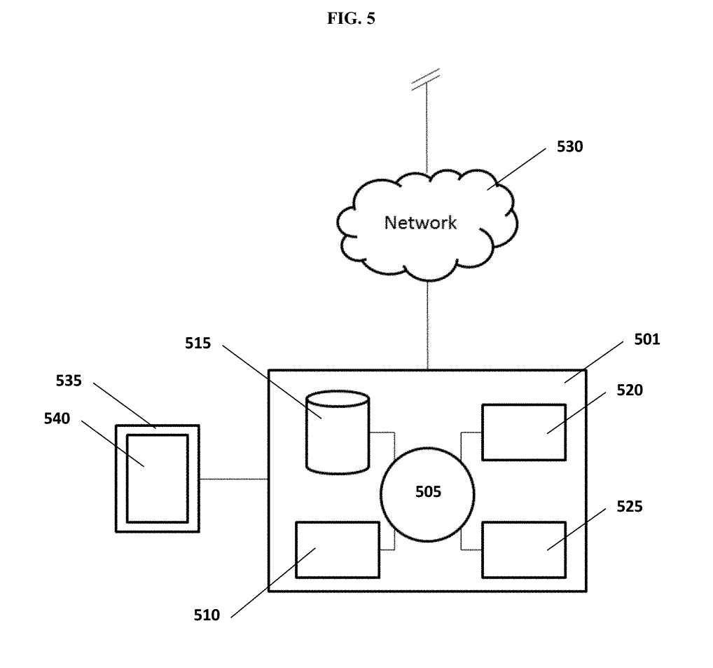

Referring to FIG. 5, in a particular embodiment, an exemplary digital processing device 501 is programmed or otherwise configured to create the long-term, multi-stage user engagement response application herein. The device 501 can regulate various aspects of the long-term, multi-stage user engagement response application of the present disclosure, such as, for example, the functionalities of re-engagement module. In this embodiment, the digital processing device 501 includes a central processing unit (CPU, also “processor” and “computer processor” herein) 505, which can be a single core or multi core processor, or a plurality of processors for parallel processing. The digital processing device 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (solid lines), such as a motherboard. The storage unit 515 can be a data storage unit (or data repository) for storing data. The digital processing device 501 can be operatively coupled to a computer network (“network”) 530 with the aid of the communication interface 520. The network 530 can be the Internet, an internet and/or extranet, or an intranet and/or extranet that is in communication with the Internet. The network 530 in some cases is a telecommunication and/or data network. The network 530 can include one or more computer servers, which can enable distributed computing, such as cloud computing. The network 530, in some cases with the aid of the device 501, can implement a peer-to-peer network, which may enable devices coupled to the device 501 to behave as a client or a server.

Continuing to refer to FIG. 5, the CPU 505 can execute a sequence of machine-readable instructions, which can be embodied in a program or software. The instructions may be stored in a memory location, such as the memory 510. The instructions can be directed to the CPU 505, which can subsequently program or otherwise configure the CPU 505 to implement methods of the present disclosure. Examples of operations performed by the CPU 505 can include fetch, decode, execute, and write back. The CPU 505 can be part of a circuit, such as an integrated circuit. One or more other components of the device 501 can be included in the circuit. In some cases, the circuit is an application specific integrated circuit (ASIC) or a field programmable gate array (FPGA).

Continuing to refer to FIG. 5, the storage unit 515 can store files, such as drivers, libraries and saved programs. The storage unit 515 can store user data, e.g., user preferences and user programs. The digital processing device 501 in some cases can include one or more additional data storage units that are external, such as located on a remote server that is in communication through an intranet or the Internet.

Continuing to refer to FIG. 5, the digital processing device 501 can communicate with one or more remote computer systems through the network 530. For instance, the device 501 can communicate with a remote computer system of a user. Examples of remote computer systems include personal computers (e.g., portable PC), slate or tablet PCs (e.g., Apple® iPad, Samsung® Galaxy Tab), telephones, Smart phones (e.g., Apple® iPhone, Android-enabled device, Blackberry®), or personal digital assistants.

Methods as described herein can be implemented by way of machine (e.g., computer processor) executable code stored on an electronic storage location of the digital processing device 501, such as, for example, on the memory 510 or electronic storage unit 515. The machine executable or machine readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

### Non-Transitory Computer Readable Storage Medium

In some embodiments, the platforms, systems, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the platforms, systems, media, and methods disclosed herein include at least one computer program, or use of the same. A computer program includes a sequence of instructions, executable in the digital processing device's CPU, written to perform a specified task. Computer readable instructions may be implemented as program modules, such as functions, objects, Application Programming Interfaces (APIs), data structures, and the like, that perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

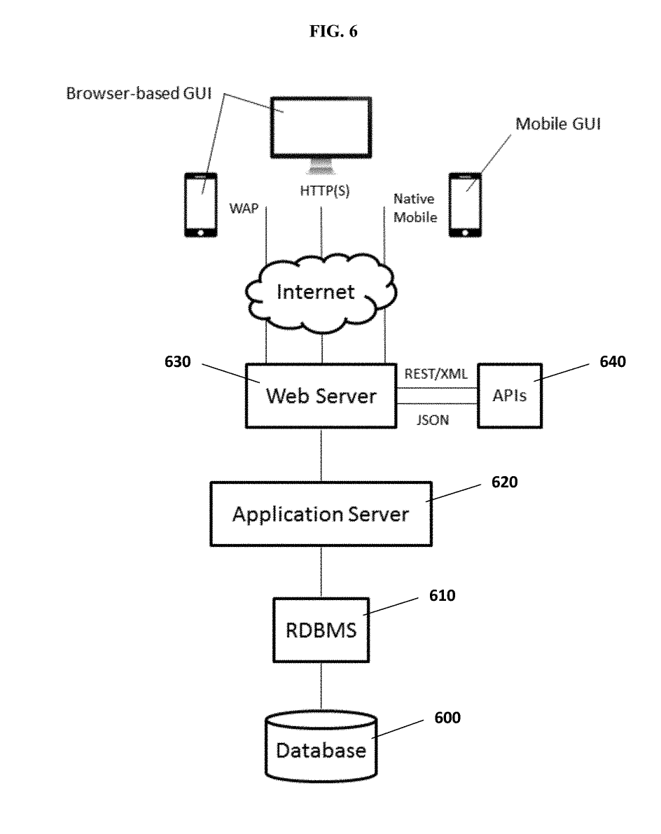

Referring to FIG. 6, in a particular embodiment, an application provision system comprises one or more databases 600 accessed by a relational database management system (RDBMS) 610. Suitable RDBMSs include Firebird, MySQL, PostgreSQL, SQLite, Oracle Database, Microsoft SQL Server, IBM DB2, IBM Informix, SAP Sybase, SAP Sybase, Teradata, and the like. In this embodiment, the application provision system further comprises one or more application severs 620 (such as Java servers, .NET servers, PHP servers, and the like) and one or more web servers 630 (such as Apache, IIS, GWS and the like). The web server(s) optionally expose one or more web services via app application programming interfaces (APIs) 240. Via a network, such as the Internet, the system provides browser-based and/or mobile native user interfaces.

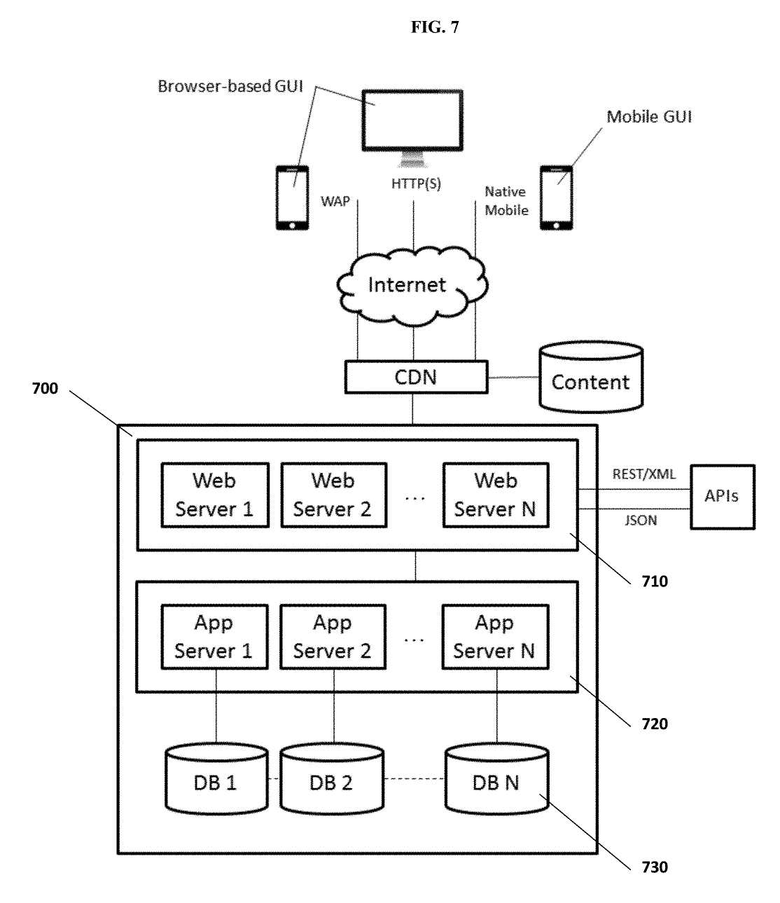

Referring to FIG. 7, in a particular embodiment, an application provision system alternatively has a distributed, cloud-based architecture 700 and comprises elastically load balanced, auto-scaling web server resources 710 and application server resources 720 as well synchronously replicated databases 730.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Google® Play, Chrome WebStore, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable compiled applications.

### Web Browser Plug-In

In some embodiments, the computer program includes a web browser plug-in (e.g., extension, etc.). In computing, a plug-in is one or more software components that add specific functionality to a larger software application. Makers of software applications support plug-ins to enable third-party developers to create abilities which extend an application, to support easily adding new features, and to reduce the size of an application. When supported, plug-ins enable customizing the functionality of a software application. For example, plug-ins are commonly used in web browsers to play video, generate interactivity, scan for viruses, and display particular file types. Those of skill in the art will be familiar with several web browser plug-ins including, Adobe® Flash® Player, Microsoft® Silverlight®, and Apple® QuickTime®.

In view of the disclosure provided herein, those of skill in the art will recognize that several plug-in frameworks are available that enable development of plug-ins in various programming languages, including, by way of non-limiting examples, C++, Delphi, Java™, PHP, Python™, and VB .NET, or combinations thereof.

Web browsers (also called Internet browsers) are software applications, designed for use with network-connected digital processing devices, for retrieving, presenting, and traversing information resources on the World Wide Web. Suitable web browsers include, by way of non-limiting examples, Microsoft® Internet Explorer®, Mozilla® Firefox®, Google® Chrome, Apple® Safari®, Opera Software® Opera®, and KDE Konqueror. In some embodiments, the web browser is a mobile web browser. Mobile web browsers (also called mircrobrowsers, mini-browsers, and wireless browsers) are designed for use on mobile digital processing devices including, by way of non-limiting examples, handheld computers, tablet computers, netbook computers, subnotebook computers, smartphones, music players, personal digital assistants (PDAs), and handheld video game systems. Suitable mobile web browsers include, by way of non-limiting examples, Google® Android® browser, RIM BlackBerry® Browser, Apple® Safari®, Palm® Blazer, Palm® WebOS® Browser, Mozilla® Firefox® for mobile, Microsoft® Internet Explorer® Mobile, Amazon® Kindle® Basic Web, Nokia® Browser, Opera Software® Opera® Mobile, and Sony® PSP™ browser.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of user's contact information, identity information, and/or other information related with the user's interaction with the link, the first message, and/or the second message. In various embodiments, suitable databases include, by way of non-limiting examples, relational databases, non-relational databases, object oriented databases, object databases, entity-relationship model databases, associative databases, and XML databases. Further non-limiting examples include SQL, PostgreSQL, MySQL, Oracle, DB2, and Sybase. In some embodiments, a database is internet-based. In further embodiments, a database is web-based. In still further embodiments, a database is cloud computing-based. In other embodiments, a database is based on one or more local computer storage devices.

As used in this specification and the claims, unless otherwise stated, the term “about,” “substantially,” and “approximately” refers to variations of less than or equal to +/−1%, +/−2%, +/−3%, +/−4%, +/−5%, +/−6%, +/−7%, +/−8%, +/−9%, +/−10%, +/−11%, +/−12%, +/−14%, +/−15%, or +/−20% of the numerical value depending on the embodiment. As a non-limiting example, about 100 meters represents a range of 95 meters to 105 meters (which is +/−5% of 100 meters), 90 meters to 110 meters (which is +/−10% of 100 meters), or 85 meters to 115 meters (which is +/−15% of 100 meters) depending on the embodiments.

The above descriptions of illustrated embodiments of the system, methods, or devices are not intended to be exhaustive or to be limited to the precise form disclosed. While specific embodiments of, and examples for, the system, methods, or devices are described herein for illustrative purposes, various equivalent modifications are possible within the scope of the system, methods, or devices, as those skilled in the relevant art will recognize. The teachings of the system, methods, or devices provided herein can be applied to other processing systems, methods, or devices, not only for the systems, methods, or devices described.

The elements and acts of the various embodiments described can be combined to provide further embodiments. These and other changes can be made to the system in light of the above detailed description.

In general, in the following claims, the terms used should not be construed to limit the system, methods, or devices to the specific embodiments disclosed in the specification and the claims, but should be construed to include all processing systems that operate under the claims. Accordingly, the system, methods, and devices are not limited by the disclosure, but instead the scopes of the system, methods, or devices are to be determined entirely by the claims.

While certain aspects of the system, methods, or devices are presented below in certain claim forms, the inventors contemplate the various aspects of the system, methods, or devices in any number of claim forms. For example, while only one aspect of the system, methods, or devices is recited as embodied in machine-readable medium, other aspects may likewise be embodied in machine-readable medium. Accordingly, the inventors reserve the right to add additional claims after filing the application to pursue such additional claim forms for other aspects of the system, methods, or devices.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

What is claimed is:

1. A computer-implemented system comprising: a digital processing device comprising: at least one processor, an operating system configured to perform executable instructions, a memory, and a computer program including instructions executable by the digital processing device to create an application for long-term, multi-stage user engagement comprising:
a) an interaction module identifying a user that interacts with a link providing access to content, wherein the identity of the user on an electronic communications platform is known, and wherein the content is associated with a product or an event;
b) a flagging module storing the user's contact information and logging the user in a database of users for a follow-up communication using the identity of the user on the electronic communications platform; and
c) a re-engagement module automatically re-engaging with the user in future by sending the user a first message comprising additional content via an interactive chat feature of the electronic communications platform, wherein the additional content is associated with the product or the event.

2. The system of claim 1, wherein the content or the additional content comprises a date associated with the product or the event.

3. The system of claim 1, wherein the content or the additional content provides information of the product or the event.

4. The system of claim 3, wherein the information is customized based on the identity of the user on the electronic communications platform.

5. The system of claim 1, wherein the re-engagement module automatically re-engages with the user by sending the user the first message substantially instantaneously after the user interacts with the link.

6. The system of claim 1, wherein the re-engagement module automatically re-engages with the user by sending the user the first message after a predetermined condition has been met.

7. The system of claim 6, wherein the predetermined condition is a duration of time, a date, a time point, or onset of an event.

8. The system of claim 1, wherein the interaction module allows the user to interact with the first message.

9. The system of claim 1, wherein the re-engagement module further automatically re-engages with the user by sending the user a second message comprising further additional content associated with the product or the event.

10. The system of claim 9, wherein the re-engagement module automatically re-engages with the user by sending the second message substantially instantaneously after the user interacts with the first message.

11. The system of claim 9, wherein the re-engagement module automatically re-engages with the user when a predetermined condition has been met after the first message has been sent.

12. The system of claim 9, wherein the interaction module allows the user to interact with the second message.

13. The system of claim 9, wherein the second message is sent via an interactive chat feature of the electronic communication platform or a second electronic communication platform.

14. The system of claim 1, wherein the further additional content provides specific features of the product or the event that is only available to the user after the user interacts with the first message, the second message, or both.

15. The system of claim 14, wherein the user interaction with the link, first message, or second message is via an input device.

16. The system of claim 1, wherein the re-engagement module allows the user to subscribe to notifications about the product or event.

17. The system of claim 9, wherein the first message or the second message comprises access allowing the user to automatically subscribe to notifications about the product or event.

18. The system of claim 1, wherein the content is an advertisement.

19. The system of claim 18, wherein the advertisement is for a movie, a new product release, a recreational event, a social event, an educational event, or a political event.

20. The system of claim 1, wherein the electronic communications platform is Facebook, Instagram, or Twitter.

21. A computer-implemented system comprising: a digital processing device comprising: at least one processor, an operating system configured to perform executable instructions, a memory, and a computer program including instructions executable by the digital processing device to create an application for long-term, multi-stage user engagement comprising:
a) an interaction module identifying a user that interacts with a link providing access to content, wherein the identity of the user on an electronic communications platform is known, and wherein the content is associated with a product or an event;
b) a response module automatically responding to the interaction with a first message comprising additional content via an interactive chat feature of the electronic communication platform, the additional content associated with the product or event;
c) a subscription module configured to allow the user to subscribe to notifications about the content;
d) a flagging module storing the user's contact information and logging the user in a database of users for a follow-up communication using the identity of the user on the electronic communications platform; and
e) a re-engagement module automatically re-engaging with the user after a predetermined condition has been met by sending the user a second message comprising further additional content via an interactive chat feature of the electronic communications platform, wherein the further additional content is associated with the product or the event.

22. A computer-implemented method of long-term, multi-stage user engagement comprising:
a) identifying a user that interacts with a link providing access to content, wherein the identity of the user on an electronic communications platform is known, and wherein the content is associated with a product or an event;
b) automatically responding to the interaction with a first message comprising additional content via an interactive chat feature of an electronic communication platform, the additional content associated with the product or event;
c) receiving a subscription from the user to receive future notifications about the content;
d) storing the user's contact information and logging the user in a database of users for a follow-up communication using the identity of the user on the electronic communications platform; and
e) automatically re-engaging with the user after a predetermined condition has been met by sending the user a second message comprising further additional content via an interactive chat feature of an electronic communication platform, wherein the further additional content is associated with the product or the event.
